(19) United States
(12) Patent Application Publication
(10) Pub. No.: US 2013/0259030 A1
(43) Pub. Date: Oct. 3, 2013

(54) SYSTEM AND METHOD FOR PROVIDING AN INDICATION OF CERTAINTY OF LOCATION OF ORIGIN OF AN INTERNET PROTOCOL EMERGENCY CALL

(71) Applicant: West Corporation, Omaha, NE (US)

(72) Inventor: Michael W. DeWeese, Brighton, CO (US)

(73) Assignee: West Corporation, Omaha, NE (US)

(21) Appl. No.: 13/890,590

(22) Filed: May 9, 2013

Related U.S. Application Data
(63) Continuation of application No. 12/712,505, filed on Feb. 25, 2010.

(51) Int. Cl. H04M 11/04

(52) U.S. Cl. CPC H04M 11/04
USPC 370/352

(57) ABSTRACT

A method for indicating certainty of origin of an IP emergency call includes: (a) entering a registered address related with an assigned telephone number for a VoIP calling instrument in a provisioning system database; (b) when the call is initiated with a VoIP Service Provider (VSP) unit having an assigned internet address; in no particular order: (1) looking up the assigned internet address in a first database to ascertain a first data element relating to a VSP unit geographic region; and (2) looking up the assigned telephone number in a second database to ascertain a second data element relating to a registration geographic region containing the registered address; (c) comparing the first and second data elements; (d) if the data elements match, delivering the call; and (e) if the data elements do not match: (1) setting a flag presenting an alert to the call taker; and (2) delivering the call.

### CROSS-REFERENCE TO RELATED APPLICATION

This application is a Continuation Application based upon U.S. patent application Ser. No. 12/712,505 entitled “SYSTEM AND METHOD FOR METHOD FOR PROVIDING AN INDICATION OF CERTAINTY OF LOCATION OF ORIGIN OF AN INTERNET PROTOCOL EMERGENCY CALL”, filed Feb. 25, 2010.

### FIELD OF THE INVENTION

The present invention is directed to emergency service telecommunication systems, and especially to handling emergency communications using internet protocol communications.

### BACKGROUND OF THE INVENTION

The present invention may be employed with special number telecommunication systems, such as abbreviated number emergency services notification and dispatch systems. Such emergency services notification and dispatch systems are commonly known as 9-1-1 systems in the United States.

The disclosed system and method provide a level of certainty regarding the origination of an internet protocol (IP) originated call to an emergency service call taker, also sometimes referred to as a 911 operator, so as to provide an indication whether the call is originating from the registered civic address.

Recent “SWATTING” situations have occurred where a telephone number (TN) has been obtained from a Voice over Internet Protocol (VoIP) service provider (VSP) and the address has been falsely or mistakenly entered into the VSP or a third party provisioning system. The false address was used to dispatch a Special Weapons Assault Team (SWAT) and property damage or personal injury involving innocent people resulted.

When the address entered into a provisioning system is a valid civic address, an emergency service call taker may have no way to verify that the provided address actually belongs to the calling individual. The provided address thus may be a fake address for the extant call. The address entered into the provisioning system (the provided address) is displayed by the Automatic Location Information (ALI) system in an emergency service telecommunication system and is the address to which an emergency service call taker should route resources responding to a 911 emergency service call. In some situations, addresses have been falsely entered into a provisioning system or may not have been timely updated to indicate currently valid address information for a “portable” calling instrument such as, by way of example and not by way of limitation, a VoIP calling instrument. In such situations when a provided telephone number is inaccurate, a provided address generated in response to a query to a data base containing a false telephone number entry may cause a public safety agency or first responder to be dispatched to an incorrect address. This situation of providing an erroneous address to an emergency call may arise when a VoIP call is made to an emergency call taker and the street address associated with the VoIP calling instrument employed for placing the call is not updated or is otherwise erroneously stored in a data base such as, by way of example and not by way of limitation, an ALI data base or an internet protocol geographic (IPGEO) data base.

Because there is no established way to know where any particular IP address is located, the best one can do is determine the region of origination, compare it to what is registered as the civic location and raise a level of certainty to the operator if a mismatch is observed. That is, the IP address that is assigned to the originating point of the caller by way of the Internet Service Provider (ISP) handling the call may be a statically or dynamically assigned IP address. As an example, a subscriber to an ISP may have a dynamic address (the dynamically assigned address) that is assigned to a network attached router or modem. The dynamically assigned address is used to identify a region from the IPGEO data base for comparison (described below). It may be necessary that the VSP pass the dynamically assigned address to the 911 gateway provider via Session Initiation Protocol (SIP) messaging. IP addresses are managed globally by the Internet Assigned Number Authority (IRNA). IRNA allocates addressing regionally to five National Internet Registries (NIR). NIRs in turn allocate numbering space to local registries or Internet Service Providers (ISPs). All information about to whom and from where address space is allocated is stored in each NIR “Whois” database where it can be easily queried, returning the State, City and Zip code of the registrar. Local ISPs obtain IP addresses and advertise those addresses through their local Border Gateway protocol (BGP) routers. Routing information is gathered by many third party companies to create geographic databases that anyone may query with an IP address to obtain the city, state and Latitude, Longitude (LAT, LON) of an IP address. It is worthwhile to note that currently this data may be accurate to only the state level. Data to a city level may be only 50% to 60% accurate; it is expected this accuracy will improve as time passes and technology evolves.

A geographic IP database may be queried during a VSP call setup. In prior art systems available today, when a VSP call arrives, one or more information data bases may be queried to provide a routing path to a Public Safety Answering Point (PSAP; sometimes referred to as a Public Safety Answering Position). A pseudo Automatic Number Identification (pANI) identifier may also be assigned. A pANI may be embodied in an Emergency Service Routing Key (ESRK) for use with wireless mobile emergency call networks. A pANI may be embodied in an Emergency Service Query Key (ESQK) for use with VoIP networks. An ESRK/ESQK is commonly a 10-digit routable—but not necessarily dialable—number that is used for routing as well as a correlator, or key, for mating data that is provided to a PSAP via different paths.

By way of example and not by way of limitation, data may be provided to a PSAP via a voice path and via an ALI data path, as well as an ESQK for an ALI information query by the PSAP Customer Premises Equipment (CPE). Additional steps may be added in the pre-call routing processes where the calling IP data address would be queried for its geographic location so that a comparison may be made between the calling TN's geographic address information stored in ALI with the calling IP geographic address. If it found that the advertised state location of the IP address does not match what is on file, an alert associated with that particular ALI record will be retrieved and displayed by the PSAP. By way of further example and not by way of limitation, other fields compared may include postal zip code, telephone area code, county, city, state or other data entries. A discrepancy flag associated with the extant call may be set when a discrepancy is detected between the calling TN geographic address and the calling IP geographic address. The discrepancy flag may accompany the extant call throughout its routing.

There is a need for a system and method for providing an indication of -certainty of location of origin of an internet protocol emergency call.

There is a need for a system and method for alerting an emergency call taker that an internet protocol emergency call is not originating from the location at which the user claims to be registered.

### SUMMARY OF THE INVENTION

A method for indicating certainty of location of origin of an IP emergency call includes: (a) entering a registered address related with an assigned telephone number for a VoIP calling instrument in a provisioning system data base; (b) when the call is initiated with a VoIP Service Provider (VSP) unit having an assigned internet address; in no particular order: (1) looking up the assigned internet address in a first data base to ascertain a first data element relating to a VSP unit geographic region; and (2) looking up the assigned telephone number in a second data base to ascertain a second data element relating to a registration geographic region containing the registered address; (c) comparing the first and second data elements; (d) if the data elements match, delivering the emergency call; and (e) if the data elements do not match: (1) setting a discrepancy flag presenting an alert to the emergency service call taker; and (2) delivering the emergency call.

A system for providing an indication of certainty of location of origin of an internet protocol emergency call including: (a) a network; (b) an internet protocol telephone service provider unit coupled with the network; the internet protocol telephone service provider unit having an assigned internet address; (c) an originating internet protocol calling instrument coupled with the internet protocol telephone service provider unit; the originating internet protocol calling instrument having an assigned telephone number; the originating internet protocol calling instrument being registered in a provisioning system data base as associated with a registered internet protocol telephone service provider system situated within a registered geographic locus; (d) an emergency call taker position coupled with the network; the network delivering the internet protocol emergency call from the originating internet protocol calling instrument via the internet protocol telephone service provider unit to the emergency service call taker; the emergency call being configured during a pre-call routing process to be accompanied by the assigned telephone number and the assigned internet address; the assigned internet address being accompanied by other data; (e) an internet address data base coupled with the emergency call taker position; the internet address data base including at least one first predetermined data element associated with a provider geographic locus within which the internet protocol telephone service provider unit is located; (f) a provider telephone number data base coupled with the emergency call taker position; the provider telephone number data base including at least one second predetermined data element associated with the registered geographic locus; (g) a comparing unit coupled with the emergency call taker position; the comparing unit permitting comparing of the at least one first predetermined data element with the at least one second predetermined data element during the pre-call routing process; and (h) a responsive element coupled with the comparing unit; if the at least one first predetermined data element substantially matches the at least one second predetermined data element, the responsive unit effecting routing of the emergency call; if the at least one first predetermined data element does not substantially match the at least one second predetermined data element, the responsive unit setting a discrepancy flag among the other data to present an alert to the emergency service call taker and effecting routing of the emergency call.

A method for alerting an emergency call taker that an internet protocol emergency call is not originating from a registered geographic locus within which its registered internet protocol telephone service provider system is located including: (a) effecting a pre-call routing process to prepare for routing the internet protocol emergency call from an originating internet protocol calling instrument via an internet protocol telephone service provider unit to the emergency service call taker; the originating internet protocol calling instrument having an assigned telephone number; the internet protocol telephone service provider unit having an assigned internet address; the emergency call being configured during the pre-call routing process to be accompanied by the assigned telephone number and the assigned internet address when routed; the assigned internet address being accompanied by other data; (b) during the pre-call routing process, in no particular order: (1) looking up the assigned internet address in an internet address data base to ascertain at least one first predetermined data element associated with a provider geographic locus within which the internet protocol telephone service provider unit is located; and (2) looking up the assigned telephone number in a provider telephone number data base to ascertain at least one second predetermined data element associated with the registered geographic locus; (c) during the pre-call routing process, comparing the at least one first predetermined data element with the at least one second predetermined data element; and (d) if the at least one first predetermined data element does not substantially match the at least one second predetermined data element, setting a discrepancy flag among the other data to effect the alerting and effecting routing of the emergency call.

It is, therefore a feature of the present invention to provide a system and method for providing an indication of certainty of region of origin of an internet protocol emergency call.

It is another feature of the present invention to provide a system and method for alerting an emergency call taker that an internet protocol emergency call is not originating from the region in which the user claims to be registered.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating a first representative system for providing an indication of certainty of location of origin of an internet protocol emergency call, or alerting an emergency call taker that an internet protocol emergency call is not originating from its registered internet protocol telephone service provider unit.

FIG. 2 is a schematic diagram illustrating a second representative system for providing an indication of certainty of location of origin of an internet protocol emergency call, or alerting an emergency call taker that an internet protocol emergency call is not originating from its registered internet protocol telephone service provider unit.

FIG. 3 is an illustration of a representative response to an ALI query.

FIG. 4 is a flow diagram illustrating a method for providing an indication of certainty of location of origin of an internet protocol emergency call.

### DETAILED DESCRIPTION

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

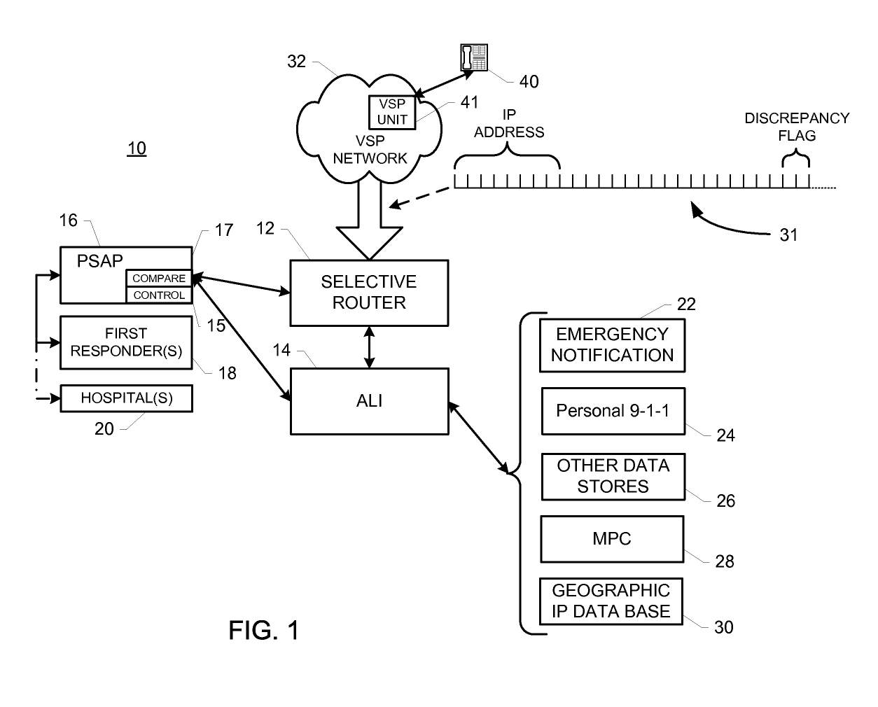

FIG. 1 is a schematic diagram illustrating a first representative system for providing an indication of certainty of location of origin of an internet protocol emergency call, or alerting an emergency call taker that an internet protocol emergency call is not originating from its registered internet protocol telephone service provider unit. Throughout this application, the term “certainty” is intended to be regarded as a relative term having a capacity for representing a lack of certainty, or ^{“}uncertainty”. By way of example and not by way of limitation, if a numerical measure or indication of “certainty” may be assigned, then a negative value for “certainty” or a value for “certainty” below a predetermined number may indicate a measure of ^{“}uncertainty”. In FIG. 1, a special number call system is represented by an emergency services call system 10. System 10 includes a selective router tandem switch 12 coupled with an Automatic Location Information (ALI) database 14. A PSAP 16 is communicatingly coupled with selective router 12. More than one PSAP may be coupled with a particular selective router 12. PSAP 16 is also coupled for communicating with ALI database 14. PSAP 16 also is coupled for communicating with first responders 18 (e.g., emergency medical, police and fire facilities; not shown in detail in FIG. 1). First responders 18 may be coupled for communication with at least one hospital 20, as indicated by a dotted line coupling first responders 18 and hospital(s) 20.

ALI database 14 is coupled for communication with an emergency notification facility 22. ALI database 14 is further coupled for querying a personal 9-1-1 database 24 and other databases, data stores and applications, represented by a block 26 (“Other Info Sources”). Personal 9-1-1 database 24 contains supplemental ALI information relating to the registered telephone numbers of callers. Personal 9-1-1 database 24 may contain critical information about subscribers' households or businesses.

9-1-1 emergency calls are received by selective router 12 from any of a variety of networks including, by way of example and not by way of limitation, a VoIP Provider (VSP) network 32. As illustrated in FIG. 1, 9-1-1 emergency calls may be received from an originating VoIP calling instrument 40 via a VSP unit 41 and a VSP network 32. Thus, a caller from a VoIP calling instrument 40 may place a 9-1-1 call that will be routed to selective router tandem 12. The 9-1-1 emergency service call is accompanied by certain data, including an originating internet address associated with said originating calling instrument and a discrepancy flag, as indicated at 31. A Mobile Positioning Center (MPC) 28 may be coupled with ALI 14 and cooperate with ALI 14 to route the 9-1-1 call to PSAP 16 and to provide position information relating to VoIP calling unit 40 for use by PSAP 16 in selecting which first responders 18 to dispatch to aid the caller using VoIP calling unit 40. Other entities coupled with ALI 14 may include an emergency notification unit 22, a personal 9-1-1 unit 24, a geographic IP data base 30 and other data stores 26.

An inquiry may be made by ALI 14 with any of data sources 22, 24, 26, 28, 30 to ascertain a first predetermined data element such as, by way of example and not by way of imitation, geographic location associated with the IP data address assigned to VoIP calling instrument 40. ALI 14 may also contain or obtain from any of data sources 22, 24, 26, 28, 30 a second predetermined data element such as, by way of example and not by way of imitation, geographic location associated with VSP unit 41. ALI 14 and data sources 22, 24, 26, 28, 30 may be regarded, individually or collectively as a provider telephone number data base. Inquiry may be made directly to one or more of data sources 22, 24, 26, 28, 30 without involving ALI 14, if desired. Direction to effect such information queries by ALI 14 may originate from PSAP 16, selective router 12 or ALI 14. It is preferred that such an information query be carried out when selective router 12 queries ALI database 14 for information; or at another time when an extant call is unequivocally a bona fide 9-1-1 call for which responsive action is being taken and for which information is required. If selective router 12 switch type does not query ALI database 14 for information, which may occur, for example where on-board selective routing database tables are uploaded from ALI 14 on a daily basis, then it is preferred that an such an information query be carried out when PSAP 16 queries ALI database 14 for information.

A controller unit 15 may control when ALI 14 effects an information query. Queries may be initiated, by way of example and not by way of limitation, at the behest or request of an operator at PSAP 16 or may be initiated when it is ascertained that the call is a VoIP call. A VoIP call should be accompanied by the IP data address of VoIP calling instrument 40. ALI 14 may inquire of geographic IP data base 30 to ascertain a geographic address associated with the received IP data address of VoIP calling instrument 40. Substantially at the same time as inquiry is made by ALI 14 of geographic data base 30, ALI 14 may inquire within its own resident data base or from another data base (e.g., other data stores 26) to ascertain a geographic address associated with VSP unit 41.

Results of the two inquiries may be compared at a compare unit 17 to ascertain whether sufficient difference exists between the two query results to regard the two results as different. Parameters evaluated to ascertain existence of a difference may include, by way of example and not by way of limitation, differences in (LAT,LON) of the two geographic results; differences in Global Positioning Satellite (GPS) coordinates; differences in cities; differences in states; or other differences in geographic location. Compare unit 17 is illustrated in FIG. 1 as being situated at PSAP 16, but compare unit 17 may alternately be situated at ALI 14, selective router 12 or elsewhere in system 10.

Personal 9-1-1 database 24 may involve subscriptions so that information may only be obtained from personal 9-1-1 database 24 if the caller placing the extant 9-1-1 call is a subscriber. Another configuration of system 10 may provide that personal 9-1-1 database 24 is a non-subscription service and ALI database 14 may query personal 9-1-1 database 24 for any 9-1-1 call to receive information contained in personal 9-1-1 database 24 for the caller placing the extant 9-1-1 call.

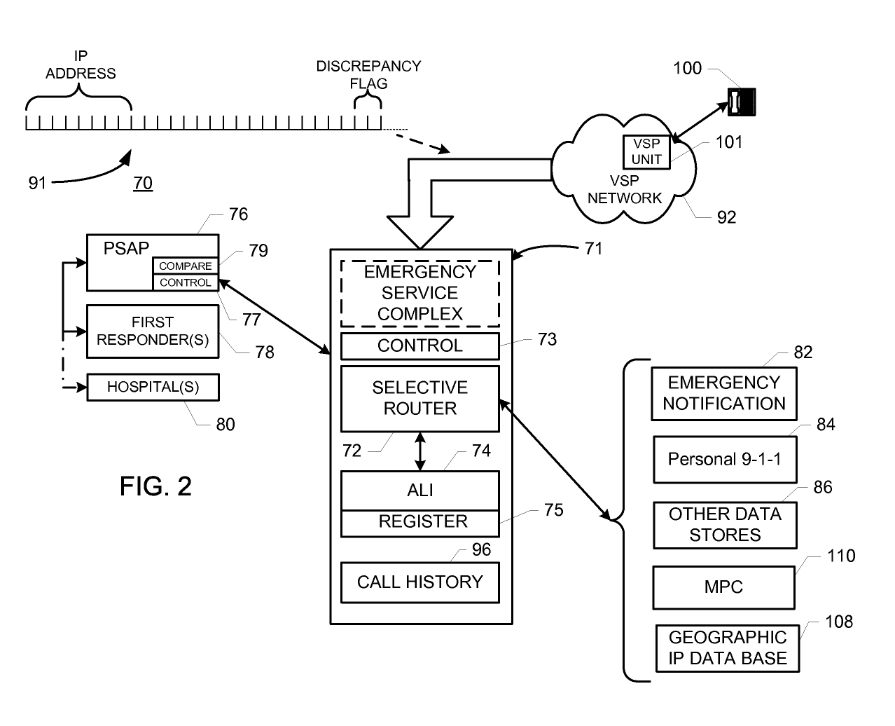

FIG. 2 is a schematic diagram illustrating a second representative system for providing an indication of certainty of location of origin of an internet protocol emergency call, or alerting an emergency call taker that an internet protocol emergency call is not originating from its registered internet protocol telephone service provider unit. In FIG. 2, a special number call system is represented by an emergency services call system 70. System 70 is configured substantially as described in U.S. Pat. No. 6,415,018 to Antonucci et al. for “Telecommunication System and Method for Handling Special Number Calls Having Geographic Sensitivity”, issued Jul. 2, 2002. System 70 includes an emergency service complex 71 that includes a selective router tandem switch 72 coupled with an Automatic Location Information (ALI) database 74. A Public Safety Answering Point (PSAP) 76 is communicatingly coupled with emergency service complex 71. Coupling PSAP 76 with emergency service complex 71 effects coupling among PSAP 76, selective router 72 and ALI database 74 (coupling details are not shown in detail in FIG. 2). PSAP 76 also is coupled for communicating with first responders 78 (e.g., emergency medical, police and fire facilities; not shown in detail in FIG. 2). First responders 78 may be coupled for communication with at least one hospital 80, as indicated by a dotted line coupling first responders 78 and hospital(s) 80.

ALI database 74 is coupled via selective router 72 in emergency service complex 71 for communication with an emergency notification facility 82. Alternatively, ALI database 74 may be coupled with emergency notification facility 82 without involving selective router 72 (not shown in FIG. 2). ALI database 74 is further coupled in a similar manner (that is, involving selective router 72 or not) for querying a personal 9-1-1 database 84 and other databases, data stores and applications, represented by a block 86 (“Other Info Sources”). Personal 9-1-1 database 84 contains supplemental ALI information relating to the telephone numbers of registered callers. Personal 9-1-1 database 84 may contain critical information about subscribers' households or businesses.

9-1-1 emergency calls are received by selective router 72 from any of a variety of networks including, by way of example and not by way of limitation, a VoIP Provider (VSP) network 92. As illustrated in FIG. 2, 9-1-1 emergency calls may be received from an originating VoIP calling instrument 100 via a VSP unit 101 and a VSP network 92. Thus, a caller from a VoIP calling instrument 100 may place a 9-1-1 call that will be routed to selective router tandem 72. The 9-1-1 emergency service call is accompanied by certain data, including an originating internet address associated with said originating calling instrument and a discrepancy flag, as indicated at 91. A Mobile Positioning Center (MPC) 110 may be coupled with ALI 74 and cooperate with ALI 74 to route the 9-1-1 call to PSAP 76 and to provide position information relating to VoIP calling unit 100 for use by PSAP 76 in selecting which first responders 78 to dispatch to aid the caller using VoIP calling unit 100. Other entities coupled with ALI 74 may include an emergency notification unit 82, a personal 9-1-1 unit 84, a geographic IP data base 108 and other data stores 86.

An inquiry may be made by ALI 74 with any of data sources 82, 84, 86, 108, 110 to ascertain a first predetermined data element such as, by way of example and not by way of imitation, geographic location associated with the IP data address assigned to VoIP calling instrument 100. ALI 74 may also contain or obtain from any of data sources 82, 84, 86, 108, 110 a second predetermined data element such as, by way of example and not by way of imitation, geographic location associated with VSP unit 101. Direction to effect such information queries by ALI 74 may originate from PSAP 76, selective router 72 or ALI 14. It is preferred that such an information query be carried out when selective router 72 queries ALI database 74 for information; or at another time when an extant call is unequivocally a bona fide 9-1-1 call for which responsive action is being taken and for which information is required. If selective router 72 switch type does not query ALI database 74 for information, which may occur, for example where on-board selective routing database tables are uploaded from ALI 74 on a daily basis, then it is preferred that an such an information query be carried out when PSAP 76 queries ALI database 74 for information.

A controller unit 77 may control when ALI 74 effects an information query. Queries may be initiated, by way of example and not by way of limitation, at the behest or request of an operator at PSAP 76 or may be initiated when it is ascertained that the call is a VoIP call. A VoIP call should be accompanied by the IP data address of VoIP calling instrument 100. ALI 74 may inquire of geographic IP data base 108 to ascertain a geographic address associated with the received IP data address of VoIP calling instrument 100. Substantially at the same time as inquiry is made by ALI 74 of geographic data base 108, ALI 74 may inquire within its own resident data base or from another data base (e.g., other data stores 86) to ascertain a geographic address associated with VSP unit 101.

This description has addressed a special number call system, represented by an emergency services call system 10 employing an Automatic Location Information (ALI) database 74. Future new generation special number call systems may employ a Location Information Service (LIS) or other database in place of or in addition to an ALI. The teachings of the present invention are regarded as applicable to such a future generation special number call system with equal relevance as those teachings apply to representative emergency services call system 10.

Results of the two inquiries may be compared at a compare unit 79 to ascertain whether sufficient difference exists between the two query results to regard the two results as different. Parameters evaluated to ascertain existence of a difference may include, by way of example and not by way of limitation, differences in (LAT, LON) of the two geographic results; differences in Global Positioning Satellite (GPS) coordinates; differences in cities; differences in states; or other differences in geographic location. Compare unit 79 is illustrated in FIG. 2 as being situated at PSAP 76, but compare unit 79 may alternately be situated at ALI 74, selective router 72 or elsewhere in system 70, including control unit 73 in emergency service complex 71.

Personal 9-1-1 database 84 may involve subscriptions so that information may only be obtained from personal 9-1-1 database 84 if the caller placing the extant 9-1-1 call is a subscriber. Another configuration of system 70 may provide that personal 9-1-1 database 84 is a non-subscription service and ALI database 74 may query personal 9-1-1 database 84 for any 9-1-1 call to receive information contained in personal 9-1-1 database 84 for the caller placing the extant 9-1-1 call.

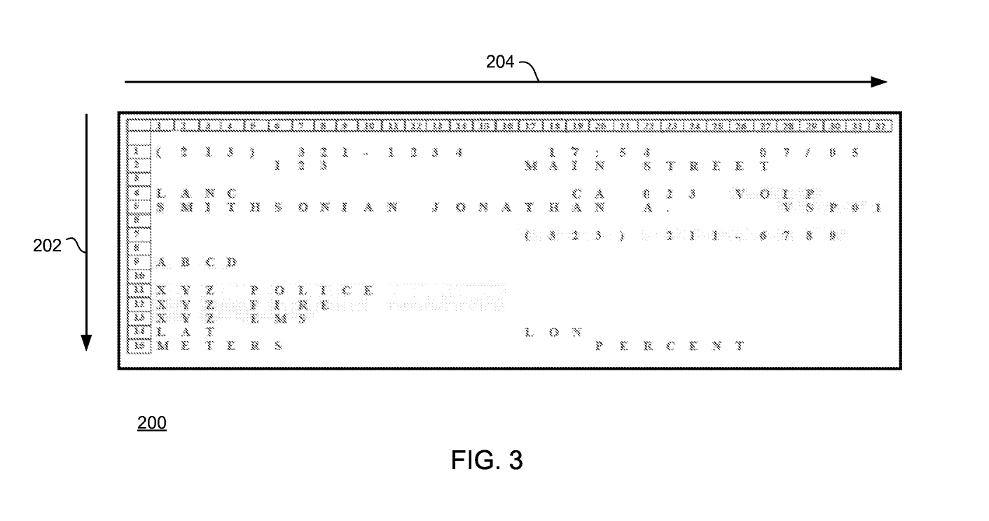

FIG. 3 is an illustration of a representative response to an ALI query. In FIG. 3, a response 200 from an ALI (e.g., ALI 14, FIG. 1) provided in answer to a query is oriented in rows 202 and columns 204. Row 1, columns 1-14 present a phone number. Row 1, columns 18-22 present a time. Row 1, columns 27-31 present a date.

Rows 2-4 present address information. Rows 5-7 present name and phone contact data. Rows 9-15 present other information.

It is worthwhile to note that gaps are present in presentations of data in response 200. Specifically, for example, rows 3, 6, 8 and 10 are void of information. Other rows 202 contain information, but are not completely filled in every column 204.

As mentioned earlier herein, this description has addressed a special number call system, represented by an emergency services call system 10 employing an Automatic Location Information (ALI) database 74. Future new generation special number call systems may employ a Location Information Service (LIS) or other database in place of or in addition to an ALI, and such future new generation systems may employ different reporting forms. The teachings of the present invention are regarded as applicable to such a future generation special number call system reporting forms with equal relevance as those teachings apply to the ALI reporting forms described herein. Various data formats may be employed to fill in blank portions of such other reporting forms such as, by way of example and not by way of limitation, an eXtensible Markup Language (XML) format.

Thus, the present invention could be instituted to convey IP geographic address information and geographic information relating to a VSP unit (e.g., VSP unit 41; FIG. 1) without having to introduce substantially new procedures or forms. Geographic information for comparing may be conveyed among elements of a telecommunication system (e.g., system 10; FIG. 1) using blank portions of already existing reporting forms.

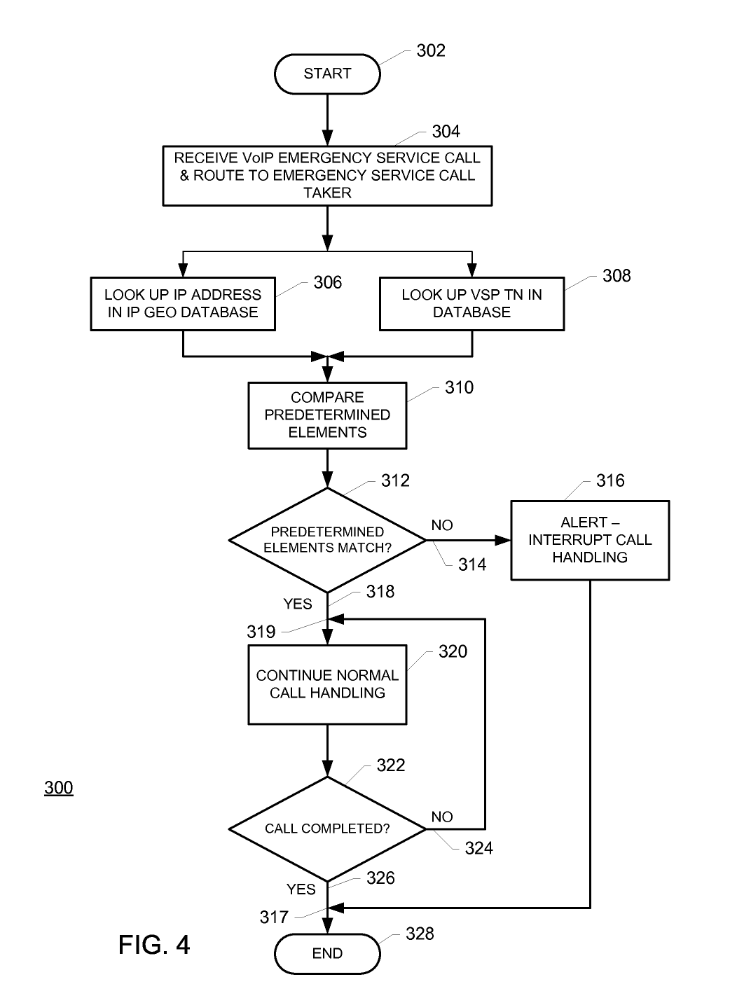

FIG. 4 is a flow diagram illustrating a method for providing an indication of certainty of location of origin of an internet protocol emergency call. In FIG. 4, a method 300 for providing an indication of certainty of location of origin of an internet protocol emergency call begins at a START locus 302. Method 300 continues with routing the internet protocol emergency call from an originating internet protocol calling instrument via an internet protocol telephone service provider unit to an emergency service call taker, as indicated by a block 304. The internet protocol telephone service provider unit has an assigned provider telephone number. The emergency call is accompanied by an internet address associated with the originating calling instrument.

Method 300 continues with in no particular order: (1) looking up the internet address in an internet address data base to ascertain at least one first predetermined data element associated with the internet address, as indicated by a block 306; and (2) looking up the provider telephone number in a provider telephone number data base to ascertain at least one second predetermined data element associated with the provider telephone number, as indicated by a block 308.

Method 300 continues with comparing the at least one first predetermined data element with the at least one second predetermined data element, as indicated by a block 310.

Method 300 continues with posing a query whether the first predetermined data element substantially matches the second predetermined data element, as indicated by a query block 312. If the at least one first predetermined data element does not substantially match the at least one second predetermined data element, method 300 proceeds from query block 313 via a NO response line 314 and an alert is presented to the emergency service call taker, as indicated by a block 316. Block 316 also indicates that the call handling of the extant emergency service call is interrupted. Method 300 proceeds from block 316 to a locus 317 and thereafter continues to terminate method 300, as indicated by an END locus 328.

If the at least one first predetermined data element substantially matches the at least one second predetermined data element, method 300 proceeds from query block 313 via a YES response line 318 and handling of the extant emergency service call continues, as indicated by a block 320.

Method 300 continues by posing a query whether the extant emergency service call is completed, as indicated by a query block 322. If the extant emergency service call is not completed, method 300 proceeds from query block 322 via a NO response line 324 to a locus 319. Method 300 proceeds from locus 319 according to steps represented by block 320 and query block 322.

If the extant emergency service call is completed, method 300 proceeds from query block 322 via a YES response line 326 and thereafter continues to terminate method 300, as indicated by an END locus 328.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A method for providing an indication of certainty of location of origin of an internet protocol emergency call; the method comprising:
(a) entering a registered address for a voice-over-internet-protocol (VoIP) calling instrument in a provisioning system data base; said registered address being related with an assigned telephone number identified with said VoIP calling instrument and including an indication of a registration geographic region for said VoIP calling instrument; said assigned telephone number and other data accompanying calls effected by said VoIP calling instrument;
(b) substantially when said internet protocol emergency call is initiated by said VoIP calling instrument with a VoIP Service Provider (VSP) via a VSP unit; said VSP unit having an assigned internet address; in no particular order:
(1) looking up said assigned internet address in a first data base to ascertain at least one first predetermined data element relating to a VSP unit geographic region associated with said assigned internet address; and
(2) looking up said assigned telephone number in a second data base to ascertain at least one second predetermined data element relating to said registration geographic region;
(c) comparing said at least one first predetermined data element with said at least one second predetermined data element;
(d) if said at least one first predetermined data element substantially matches said at least one second predetermined data element, delivering said emergency call; and
(e) if said at least one first predetermined data element does not substantially match said at least one second predetermined data element:
(1) setting a discrepancy flag among said other data to present an alert to said emergency service call taker; and
(2) delivering said emergency call.

2. The method for providing an indication of certainty of location of origin of an internet protocol emergency call as recited in claim 1 wherein said provisioning system data base is an Automatic Location Information (ALI) data base.

3. The method for providing an indication of certainty of location of origin of an internet protocol emergency call as recited in claim 1 wherein said first predetermined data element includes at least one of latitude-longitude information, global positioning satellite coordinates, city information, state information, postal zip code information and telephone area code information relating to a geographic location in which said VSP unit is situated.

4. The method for providing an indication of certainty of location of origin of an internet protocol emergency call as recited in claim 1 wherein said second predetermined data element includes at least one of latitude-longitude information, global positioning satellite coordinates, city information, state information, postal zip code information and telephone area code information relating to a geographic location associated with said registration geographic region.

5. The method for providing an indication of certainty of location of origin of an internet protocol emergency call as recited in claim 3 wherein said second predetermined data element includes at least one of latitude-longitude information, global positioning satellite coordinates, city information, state information, postal zip code information and telephone area code information relating to a geographic location associated with said registration geographic region.

6. The method for providing an indication of certainty of location of origin of an internet protocol emergency call as recited in claim 2 wherein said first predetermined data element includes at least one of latitude-longitude information, global positioning satellite coordinates, city information, state information, postal zip code information and telephone area code information relating to a geographic location in which said VSP unit is situated.

7. The method for providing an indication of certainty of location of origin of an internet protocol emergency call as recited in claim 2 wherein said second predetermined data element includes at least one of latitude-longitude information, global positioning satellite coordinates, city information, state information, postal zip code information and telephone area code information relating to a geographic location associated with said registration geographic region.

8. The method for providing an indication of certainty of location of origin of an internet protocol emergency call as recited in claim 6 wherein said second predetermined data element includes at least one of latitude-longitude information, global positioning satellite coordinates, city information, state information, postal zip code information and telephone area code information relating to a geographic location associated with said registration geographic region.

9. A method for alerting an emergency call taker that an internet protocol emergency call is not originating from a registered geographic locus within which its registered internet protocol telephone service provider system is located; the method comprising:
(a) effecting a pre-call routing process to prepare for routing said internet protocol emergency call from an originating internet protocol calling instrument via an internet protocol telephone service provider unit to said emergency service call taker; said originating internet protocol calling instrument having an assigned telephone number; said internet protocol telephone service provider unit having an assigned internet address; said emergency call being configured during said pre-call routing process to be accompanied by said assigned telephone number and said assigned internet address when routed; said assigned internet address being accompanied by other data;
(b) during said pre-call routing process, in no particular order:
(1) looking up said assigned internet address in an internet address data base to ascertain at least one first predetermined data element associated with a provider geographic locus within which said internet protocol telephone service provider unit is located; and
(2) looking up said assigned telephone number in a provider telephone number data base to ascertain at least one second predetermined data element associated with said registered geographic locus;
(c) during said pre-call routing process, comparing said at least one first predetermined data element with said at least one second predetermined data element; and
(d) if said at least one first predetermined data element does not substantially match said at least one second predetermined data element, setting a discrepancy flag among said other data to effect said alerting and effecting routing of said emergency call.

10. The method for alerting an emergency call taker that an internet protocol emergency call is not originating from a registered geographic locus within which its registered internet protocol telephone service provider system is located as recited in claim 9 wherein said provider telephone number data base is an Automatic Location Information (ALI) data base.

11. The method for alerting an emergency call taker that an internet protocol emergency call is not originating from a registered geographic locus within which its registered internet protocol telephone service provider system is located as recited in claim 9 wherein said first predetermined data element includes at least one of latitude-longitude information, global positioning satellite coordinates, city information, state information, postal zip code information and telephone area code information relating to a geographic location in which said internet protocol telephone service provider unit is situated.

12. The method for alerting an emergency call taker that an internet protocol emergency call is not originating from a registered geographic locus within which its registered internet protocol telephone service provider system is located as recited in claim 9 wherein said second predetermined data element includes at least one of latitude-longitude information, global positioning satellite coordinates, city information, state information, postal zip code information and telephone area code information relating to a geographic location associated with said registered geographic locus.

13. The method for alerting an emergency call taker that an internet protocol emergency call is not originating from a registered geographic locus within which its registered internet protocol telephone service provider system is located as recited in claim 11 wherein said second predetermined data element includes at least one of latitude-longitude information, global positioning satellite coordinates, city information, state information, postal zip code information and telephone area code information relating to a geographic location associated with said registered geographic locus.

14. The method for alerting an emergency call taker that an internet protocol emergency call is not originating from a registered geographic locus within which its registered internet protocol telephone service provider system is located as recited in claim 10 wherein said first predetermined data element includes at least one of latitude-longitude information, global positioning satellite coordinates, city information, state information, postal zip code information and telephone area code information relating to a geographic location in which said internet protocol telephone service provider unit is situated.

15. The method for alerting an emergency call taker that an internet protocol emergency call is not originating from a registered geographic locus within which its registered internet protocol telephone service provider system is located as recited in claim 10 wherein said second predetermined data element includes at least one of latitude-longitude information, global positioning satellite coordinates, city information, state information, postal zip code information and telephone area code information relating to a geographic location associated with said registered geographic locus.

16. The method for alerting an emergency call taker that an internet protocol emergency call is not originating from a registered geographic locus within which its registered internet protocol telephone service provider system is located as recited in claim 14 wherein said second predetermined data element includes at least one of latitude-longitude information, global positioning satellite coordinates, city information, state information, postal zip code information and telephone area code information relating to a geographic location associated with said registered geographic locus.

17. A system for providing an indication of certainty of location of origin of an internet protocol emergency call; the system comprising:
(a) a network;
(b) an internet protocol telephone service provider unit coupled with said network; said internet protocol telephone service provider unit having an assigned internet address;
(c) an originating internet protocol calling instrument coupled with said internet protocol telephone service provider unit; said originating internet protocol calling instrument having an assigned telephone number; said originating internet protocol calling instrument being registered in a provisioning system data base as associated with a registered internet protocol telephone service provider system situated within a registered geographic locus;
(d) an emergency call taker position coupled with said network; said network delivering said internet protocol emergency call from said originating internet protocol calling instrument via said internet protocol telephone service provider unit to said emergency service call taker; said emergency call being configured during a pre-call routing process to be accompanied by said assigned telephone number and said assigned internet address; said assigned internet address being accompanied by other data;
(e) an internet address data base coupled with said emergency call taker position; said internet address data base including at least one first predetermined data element associated with a provider geographic locus within which said internet protocol telephone service provider unit is located;
(f) a provider telephone number data base coupled with said emergency call taker position; said provider telephone number data base including at least one second predetermined data element associated with said registered geographic locus;
(g) a comparing unit coupled with said emergency call taker position; said comparing unit permitting comparing of said at least one first predetermined data element with said at least one second predetermined data element during said pre-call routing process; and
(h) a responsive element coupled with said comparing unit; if said at least one first predetermined data element substantially matches said at least one second predetermined data element, said responsive unit effecting routing of said emergency call; if said at least one first predetermined data element does not substantially match said at least one second predetermined data element, said responsive unit setting a discrepancy flag among said other data to present an alert to said emergency service call taker and effecting routing of said emergency call.

18. The system for providing an indication of certainty of location of origin of an internet protocol emergency call as recited in claim 17 wherein said internet address data base includes at least one of latitude-longitude information, global positioning satellite coordinates, city information, state information, postal zip code information and telephone area code information relating to said provider geographic locus.

19. The system for providing an indication of certainty of location of origin of an internet protocol emergency call as recited in claim 18 wherein said provider telephone number data base includes at least one of latitude-longitude information, global positioning satellite coordinates, city information, state information, postal zip code information and telephone area code information relating to said registered geographic locus.

20. The system for providing an indication of certainty of location of origin of an internet protocol emergency call as recited in claim 19 wherein said provisioning system data base is an Automatic Location Information (ALI) data base.
